(19) United States
(12) Patent Application Publication
(10) Pub. No.: US 2026/0317248 A1
(43) Pub. Date: Oct. 15, 2026

(54) MICROALGAE EXTRACTS FOR INHIBITING NITRIFICATION AND/OR DENITRIFICATION PROCESSES IN SOIL

(71) Applicants: AGRO INNOVATION INTERNATIONAL, SAINT-MALO (FR); INSTITUT NATIONAL DE RECHERCHE POUR L'AGRICULTURE L'ALIMENTATION ET L'ENVIRONNEMENT, PARIS (FR); UNIVERSITE DIJON BOURGOGNE, DIJON (FR); INSTITUT NATIONAL SUPERIEUR DES SCIENCES AGRONOMIQUES DE L'ALIMENTATION ET DE L'ENVIRONNEMENT, DIJON (FR)

(72) Inventors: Rozenn TREPOS, SAINT-MALO (FR); Arkoun MUSTAPHA, SAINT-MALO (FR); Catherine HENAULT, DIJON CEDEX (FR)

(21) Appl. No.: 19/483,836

(22) PCT Filed: May 10, 2024
(86) PCT No.: PCT/FR2024/050608

§ 371 Date: Nov. 12, 2025

(30) Foreign Application Priority Data
May 12, 2023 (FR) FR2304740

(51) Int. Cl. C05F 11/00; C05G 3/90

(52) U.S. Cl. CPC C05F 11/00; C05G 3/90

(57) ABSTRACT

The present invention is suitable for use in the agricultural field and relates to the use of eukaryotic microalga extracts for controlling nitrification in soils and reducing nitrogen gas losses in the form of N₂O.

### TECHNICAL FIELD

The invention relates to the use of microalga extracts in a soil fertilization method to inhibit the nitrification process and/or the nitrification-denitrification process as well as the nitrate denitrification process. These extracts have the property of controlling the functioning of nitrifying bacteria and/or nitrifying-denitrifying bacteria which are responsible for the transformation of ammoniacal nitrogen (NH₄⁺) into nitric nitrogen (NO₃⁻) with release of nitrous oxide (N₂O) during this process. These extracts also have the property of inhibiting the functioning of the nitrate reductase enzyme.

The invention proposes a new method for controlling both the nitrogen supply to the soil and the supply of fertilizers to the plant, but also for limiting emissions of the greenhouse gas N₂O.

### PRIOR ART

Nitrogen fertilization plays a vital role in crop growth and yield. Nitrogen is the characteristic constituent of amino acids and proteins, making it a very important growth and quality factor. As it undergoes a natural cycle in the air, soil, and water, it undergoes various chemical and biological transformations, this is the nitrogen cycle.

The global nitrogen cycle describes the transformations of nitrogen gas, mineral nitrogen, and nitrogen-rich organic compounds present on Earth. It is a set of processes involving soil microorganisms. This includes biological nitrogen fixation, nitrogen assimilation by plants, ammonification, nitrification, and denitrification.

Among all these processes, nitrification corresponds to the oxidation of ammonium (NH₄⁺) into nitrate (NO₃⁻), it goes through several steps. First of all, bacteria and archaea of the Nitrosomas group, AOB (Ammonia-Oxidizing Bacteria) and AOA (Ammonia-Oxidising archaea) allow ammonium to be oxidized into hydroxylamine (NH₂OH) then into nitrite (NO₂). Finally, it is the Nitrite-Oxidising Bacteria (NOB), Nitrobacter and Nitrospira, that allow to oxidize nitrites into nitrate. In order to transform ammonium into nitrites, four protons are released as well as two water molecules, this phenomenon causes acidification of the environment, particularly around the roots. The activity of bacteria, AOB and AOA, is highly dependent on the environment, so that humidity, pH, temperature and the availability of ammonium have a great influence on the process. Finally, emissions of nitrous oxide (N₂O) caused by nitrification can be observed during the oxidation of ammonium into nitrite.

Nitrification is an important biological step in the soil nitrogen cycle. From an agronomic perspective, its operation is considered a limiting step in the nitrogen supply of soils. If it occurs too slowly or too quickly compared to plant needs, it can lead to low nitrogen use efficiency and can contribute to groundwater pollution and greenhouse gas emissions (N₂O). The nitrification rate can vary depending on the nature of the soil. Factors regulating the nitrification process include soil pH, temperature, humidity, nitrogen fertilizer applied to the soil, microorganisms, and the physical nature of the soil.

Nitrification poorly synchronized with nitrogen assimilation by plants leads to a loss of nitrogen applied to the soil through nitrate leaching and nitrous oxide (N₂O) emissions. These losses can account for one-fifth of the applied nitrogen. This leads to increased agricultural production costs, environmental pollution (surface and deep waters), human and animal diseases, ozone layer depletion, and greenhouse gas emissions that contribute to climate change. Therefore, controlling the nitrification process has become a major issue in agriculture.

Another important process in the nitrogen cycle is the transformation of nitrates resulting from nitrification into nitrogen. This second biological mechanism, denitrification, involves the reduction of nitrates (NO₃⁻) into nitrogen gas (N₂) by bacteria in anoxic conditions. Denitrifying bacteria successively reduce the nitrate ion (NO₃⁻) into nitrite ion (NO₂⁻), then into nitric oxide (NO), into nitrous oxide (N₂O), and finally into nitrogen (N₂).

Denitrification therefore constitutes another source of emission of the greenhouse gas N₂O through bacterial use of nitrates, which competes with the use of nitrates by plants. There is also a nitrification-denitrification process carried out by nitrifying organisms that are also capable of denitrification, or carried out jointly by nitrifying organisms and separate denitrifying organisms, in which the nitrates produced by the nitrifying organisms are immediately denitrified by the denitrifying organisms. N₂O emissions can also be observed at the stage of the nitrification-denitrification process.

For non-nitrogen-fixing plants, nitrogen is absorbed by plants primarily in nitric (NO₃⁻) or ammoniacal (NH₄⁺) form. Depending on the plant's needs, it is capable of absorbing significant amounts to support its growth and development. Moreover, a lack of nitrogen caused by a deficient supply from the soil or by losses to the environment, via ammonia volatilization, nitrate leaching or denitrification, can cause nitrogen deficiencies and have a negative impact on plant growth.

Providing fertilizer solutions that are less prone to environmental losses helps avoid certain risks of deficiencies and limit the environmental impacts of fertilizers. Thus, the amounts of nitrogen added through fertilization can be reduced, which can represent a financial gain for farmers, help reduce nitrogen losses and reduce environmental risks.

In order to control the nitrogen transformation process in the soil, formulations containing nitrification inhibitors are interesting to develop with the aim of controlling the nitrate supply according to the needs of the plant and optimizing its use by crops. This allows for better nitrogen utilization by the plant, while reducing negative consequences for the environment.

Today, there are several chemical molecules capable of inhibiting the nitrification process in the soil and limiting greenhouse gas emissions. However, these are synthetic molecules that can pose a danger to the environment and soil life.

It is in this context that the applicant has demonstrated, and this constitutes the basis of the present invention, that certain natural extracts of microalgae allow to inhibit the nitrification and/or nitrification-denitrification process in a soil and consequently to improve the agro-environmental balance of crops. The applicant has also demonstrated that these microalga extracts allow to inhibit the functioning of the nitrate reductase enzyme.

Thus, the present invention, which is suitable for use in the agricultural field, aims at proposing the use of natural extracts of microalgae as a solution to slow down nitrification and thus better regulate the supply of nitrogen to plants, reduce nitrogen gas losses in the form of N₂O. It is also possible to consider reducing nitrate losses by leaching.

### DISCLOSURE OF THE INVENTION

The use of microalga extracts in agriculture to control one or more processes of the nitrogen cycle is an innovative approach. This is the main agronomic challenge of the invention.

Thus, the present invention is based on the use of an extract of at least one eukaryotic microalga to induce an inhibition of at least one step of the nitrogen cycle in a soil, said step being selected from a nitrification process, a denitrification process and a nitrification-denitrification process. The eukaryotic microalga extract may be an aqueous extract or an oily extract.

The present invention relates to an agricultural fertilization method comprising a step of supplying to a soil an extract of at least one eukaryotic microalga, said extract being able to be applied in the open field or on a culture medium, supplied by a culture medium containing same, or supplied by a culture solution.

The extract may be provided by a product for agricultural use comprising, in addition to the extract of a eukaryotic microalga, also at least one soil nutrient ingredient or a plant nutrient ingredient selected in particular from a fertilizer, an amendment, a biostimulant and a micronutrient.

A method for preparing an aqueous extract of a microalga useful in the context of the invention may comprise an extraction step by introducing the microalga into a liquid extraction medium comprising water, a filtration step, and a step of recovering the filtrate containing the aqueous extract.

### BRIEF DESCRIPTION OF THE DRAWINGS

FIG. 1 represents the evolution of ammonium contents (NH₄⁺; mg N-NH₄⁺·g⁻¹ Soil) in the soil (i) with a soil that comprises a functionalized microalga extract, (ii) with a soil that comprises a microalga extract (Extract), and (iii) with a soil that does not comprise an extract (Control). The graph shows a progressive decrease in ammonium contents between 0 and 12 days of incubation in the soil that does not comprise an extract (Control): these contents increase from 0.4 to 0.12 mg N-NH₄⁺·g⁻¹ Soil. Ammonium levels increased from 0.4 to 0.31 mg N-NH₄⁺·g⁻¹ Soil in the soil that comprises the microalga extract, and from 0.4 to 0.42 mg N-NH₄⁺·g⁻¹ Soil in the soil that comprises the functionalized microalga extract, indicating an inhibition of the nitrification process in the soil.

FIG. 2 shows the evolution of nitrate levels (NO₃⁻; mg N-NO₃⁻·g⁻¹ Soil) in soil (i) with a soil that comprises a functionalized microalga extract, (ii) with a soil that comprises a microalga extract (Extract), and (iii) with a soil that does not comprise an extract (Control). The graph shows a progressive increase in nitrate levels between 0 and 12 days of incubation in the soil that does not comprise an extract (Control): these levels increase from 0 to 0.22 mg N-NO₃⁻·g⁻¹ Soil in the soil. Ammonium levels increase from 0 to 0.15 mg N-NO₃⁻·g⁻¹ Soil in the soil that comprises the microalga extract, and from 0 to 0.09 mg N-NO₃⁻·g⁻¹ Soil in the soil that comprises the functionalized microalga extract, indicating an inhibition of the nitrification process in the soil.

FIG. 3 shows the evolution of nitrous oxide (N₂O) contents; represented by the peak area of the GC (gas chromatography) analysis in the soil (i) with a soil that comprises a functionalized microalga extract (Functionalized Extract), and (ii) with a soil that does not comprise an extract (Control). The graph shows a progressive increase in the peak area associated with an increase in N₂O contents in the air between 0 and 216 hours of incubation in the soil that does not comprise an extract (Control): the peak area increases from 0 to 1200. The peak area increases from 0 to 600 in the soil that comprises the functionalized microalga extract, indicating an inhibition of N₂O production thanks to the functionalized microalga extract.

FIG. 4 shows the percentage inhibition (%) of nitrate reductase functioning (i) with a solution that comprises a functionalized microalga extract, (ii) with a solution that comprises a microalga extract (Extract), and (iii) with a solution that does not comprise an extract (Control). The graph shows an inhibition of nitrate reductase activity of 24% in the solution that comprises the microalga extract, and of 99% in the solution that comprises the functionalized microalga extract, compared to the solution that does not comprise an extract (Control).

FIG. 5 shows the inhibition percentage (%) of nitrate reductase functioning (i) with a solution that comprises a functionalized microalga extract, (ii) with a solution that comprises a microalga extract (Extract), and (iii) with a solution that does not comprise an extract (Control). The graph shows an inhibition of nitrate reductase activity of 28.9% in the solution that comprises the spirulina extract, and of 59.6% in the solution that comprises the functionalized spirulina extract, compared to the solution that does not comprise an extract (Control). The graph also shows an inhibition of nitrate reductase activity of 13.8% in the solution that comprises the chlorella extract, and of 49.9% in the solution that comprises the functionalized chlorella extract, compared to the solution that does not comprise an extract (Control).

FIG. 6 shows the percentage inhibition (%) of nitrate reductase functioning (i) with a rapeseed oil-based solution (HC), (ii) with a soybean oil-based solution (HS), (iii) with a solution that comprises a microalga extract in rapeseed oil, (iv) with a solution that comprises a microalga extract in soybean oil, and (v) with a solution that does not comprise an extract (Control). The graph shows an inhibition of nitrate reductase activity of 19.6% in the solution that comprises rapeseed oil (HC bar), and of 36.3% in the solution that comprises chlorella extract in rapeseed oil (Chlorella Extract-HC bar), compared to the solution that does not comprise an extract (Control). The graph also shows an inhibition of nitrate reductase activity of 27.2% in the solution that comprises soybean oil (HS bar), and 36.8% in the solution that comprises chlorella extract in soybean oil (Chlorella Extract-HS bar), and 37.9% in the solution that comprises Nannochloropsis extract in soybean oil (Nannochloropsis Extract-HS bar), compared to the solution that does not comprise extract (Control).

### DESCRIPTION OF THE EMBODIMENTS

The invention therefore relates to the use of an extract of at least one eukaryotic microalga to induce an inhibition of at least one step of the nitrogen cycle in a soil, said step being selected from a nitrification process, a denitrification process and a nitrification-denitrification process, and relates in particular to a method for fertilizing a soil harboring bacteria, by supplying to said soil an agricultural product comprising an aqueous extract of eukaryotic microalga(e).

The microalga extract can be an aqueous extract or an oily extract. In a particular implementation, the oily extract of eukaryotic microalga allows to inhibit a denitrification process in a soil.

“Eukaryotic microalgae” are unicellular microorganisms that have the ability to photosynthesize. Nitrification processes are defined as the set of biochemical reactions leading to the formation of nitrates from ammonium that are induced by nitrifying bacteria such as ammonia-oxidizing bacteria (AOB) and/or nitrite-oxidizing bacteria (NOB). Examples of nitrifying bacteria genera are Nitrobacter spp., Nitrosomonas spp., Nitrosospira spp. and Nitrosococcus spp. Nitrosomonas spp., Nitrosospira spp. and Nitrosococcus spp., including the species Nitrosomonas europaea, Nitrosomonas eutropha, Nitrosomonas communis, Nitrosospira multiformis and Nitrosospira lacus.

The term “nitrification process inhibitor”, also known as a nitrification inhibitor, refers to a product whose activity slows down one of the biochemical reactions in the nitrification process. A nitrification inhibitor advantageously allows for better synchronization of the soil's nitrogen supply with the plant's needs and consequently reduces nitrogen fertilizer losses (for example, leaching of nitrates from the soil). In addition, since nitrification can produce N₂O, a nitrification inhibitor can reduce N₂O emissions from soils.

Inhibition of a nitrification process within the scope of the invention may have at least one effect selected from inhibition of the activity of nitrifying bacteria present in the soil, reduction of fertilizer loss from the soil, reduction of nitrate leaching in the soil, increase in the amount of ammonium available in the soil, improvement of the growth of a plant cultivated on the soil, reduction of nitrous oxide emissions, and increase in the amount of nitrogen available for assimilation by a plant cultivated on the soil.

A microalgae extract covered by the present invention may be a nitrification inhibitor within the meaning of the invention. In a particular embodiment of the invention, a microalgae extract is a nitrification inhibitor when it reduces by at least 5% the amount of nitrate nitrogen (N—NO₃⁻) in an amended soil compared to the same soil not amended with the extract, and/or when it increases by at least 5% the amount of ammoniacal nitrogen (N—NH₄⁺) in an amended soil compared to the same soil not amended with the extract, after a period of at least 2 days after application of the extract to the soil, preferably at least 6 days or 10 days. Several methods for measuring the nitrification inhibition activity of a microalga extract are detailed in the examples. The decrease in the amount of nitrate nitrogen or the increase in the amount of ammoniacal nitrogen may be independently of one another greater than or equal to a value selected from 5%, 10%, 20%, 30%, 40%, 50%, 60%, 70%, 80%, 90%, 100%, 150%, 200% and 250%, after a duration of, for example, at least 2 days after application of the extract to the soil, preferably at least 6 days or 10 days.

The term “denitrification process” refers to the reduction of nitrates (NO₃⁻) into nitrogen gas (N₂) by denitrifying bacteria in anoxic conditions. More precisely, the bacteria reduce the nitrate ion (NO₃⁻) successively into nitrite ion (NO₂) by the action of the enzyme N₂O reductase, into nitric oxide (NO), into nitrous oxide (N₂O), then into nitrogen (N₂). The denitrifying bacteria concerned include Thiobacillus denitrificans, Micrococcus denitrificans, Pseudomonas aeruginosa, Pseudomonas stutzeri, Serratia spp., and Achromobacter spp.

A “denitrification inhibitor” is a product for slowing down at least one step of the denitrification process. In a particular embodiment, a denitrification inhibitor reduces the activity of the nitrate reductase enzyme by at least 5% in a medium supplemented with a denitrification inhibitor compared to the same medium without supplementation after a period of at least 10 minutes. The decrease in the activity of the Nitrate Reductase enzyme may be greater than a value selected from 5%, 10%, 20%, 30%, 40%, 50%, 60%, 70%, 80%, 90% and 95%, after a duration of at least 10 minutes, for example.

Inhibition of a denitrification process may have at least one effect selected from inhibition of the activity of denitrifying bacteria present in the soil, inhibition of the nitrate reduction process, inhibition of the activity of the enzyme nitrate reductase, and reduction of nitrous oxide emission.

A “nitrification-denitrification process” means a process carried out by organisms capable of simultaneous nitrification and denitrification, or a process carried out jointly by separate nitrifying and denitrifying organisms, in which the nitrates produced by the nitrifying organisms are immediately denitrified by the denitrifying organisms.

The term “nitrification-denitrification process inhibitor” refers to the activity of limiting the nitrification-denitrification process which may result in an inhibition of the production of N₂O. Also, the inhibition of a nitrification-denitrification process may have the effect of reducing the production of nitrous oxide. The reduction in the production of nitrous oxide may be greater than or equal to a value selected from 5%, 10%, 20%, 30%, 40%, 50%, after a duration of, for example, at least 100 hours, 150 hours or 200 hours.

In one embodiment of the invention, a microalga extract is a nitrification-denitrification inhibitor when it reduces by at least 5% the amount of nitrous oxide in a soil amended with microalga extract compared to the same unamended soil under nitrification conditions (aerated environment).

When the soil harbors denitrifying bacteria, the step of adding the microalga extract causes the inhibition of the activity of these bacteria.

When the soil harbors nitrifying bacteria, the step of adding the microalga extract causes the inhibition of the activity of these bacteria.

The term “microalga extract” refers to a product resulting from a method carried out by humans to isolate a part of a microalga. The microalga is preferably a eukaryotic microalga: it is delimited by a membrane and contains organelles, including a cytoplasm and a nucleus.

The term “aqueous microalga extract” refers to a product resulting from the extraction of the cellular contents of a microalga with a liquid containing water. An aqueous extract does not necessarily contain water, as the extraction step may be followed by a step of removing the water used as an extraction solvent. The aqueous extract preferably contains the hydrophilic molecules contained within the microalga. The aqueous extract is therefore likely to be obtained by extracting the molecules contained within the microalga, with a liquid medium containing water.

The aqueous extract of at least one eukaryotic microalga can be obtained by a step of extracting the organelles contained in the cell, using a liquid extraction medium preferably consisting of water, more preferably distilled water, and the extraction step preferably being carried out at a temperature ranging from 4° C. to 300° C. The aqueous extract can be functionalized by adding at least one enzyme to the liquid medium. The enzyme can be selected from proteases, carboxypeptidases, catalases, cellulases, glucanases, hemicellulases, lipases, amylase, phospholipases. In a particular embodiment, the enzyme is selected from carbohydrases and pectinases. Examples of carbohydrases are cellulases, hemicellulases, beta-glucanases, and xylanases.

The term “microalgal oil extract” refers to a product resulting from the extraction of the cellular contents of a microalga with a liquid containing an oil. The oil may be a vegetable oil, such as soybean oil or rapeseed oil. The oil extract contains lipophilic molecules contained within the microalgal cells. The microalgal oil extract may be obtained by a lysis method consisting of breaking the cell membrane to release the liquid contents of the microalga.

The oily extract of at least one eukaryotic microalga can alternatively be obtained by a step of extracting the molecules contained in the cell, by placing the microalgae in an oil at a temperature ranging from 4° C. to 300° C. The oil loaded with lipophilic molecules from the contents of the microalgae can then be separated from the treated microalgae, by filtration or by centrifugation.

The microalga which can be used in the context of the present invention is for example a microalga belonging to a genus selected from the group consisting of Amphora sp., Arthrospira sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nannochloropsis sp., Nitzchi sp., Odonthella sp., Porphyridium sp., Phaeodacylum sp., Scenedesmus sp., Schyzotrium sp., Skeletonema sp., Thalassosira sp. and Tetraselmis sp. The microalga belonging to one of the genera mentioned above may be any species of microalga known to the person skilled in the art belonging to one of these genera.

Examples of particular microalgae species are Nannochloropsis saliuna, Nannochloropsis oculata, Nannochloropsis oceanica, Arthrospira platensis and Chlorella sorokiniana.

The invention applies to a method for fertilizing a soil comprising a step of providing a microalga extract which is applied to the soil, provided to the soil by a culture solution, or which is integrated into the soil, when the soil is a culture medium.

The term “soil” refers to the substrate explored by the roots of cultivated plants on which they develop. The term soil comprises any type of substrate on which a plant can develop, such as, for example, artificial soil, cultivated agricultural soil, uncultivated agricultural soil, peat, potting soil, rock wool or coconut fiber. The term soil therefore covers culture media used for so-called “soilless” cultivation, for example in pots. In a particular embodiment of the invention, a “soil” does not comprise a plant, and in particular does not comprise the root system of a plant. A soil may comprise a mixture of minerals, organisms, organic matter and air. It may comprise microorganisms, among which are nitrifying microorganisms and/or denitrifying microorganisms known to the person skilled in the art, some of which have been described previously. The microorganisms may comprise nitrate reductase enzymes.

The inventors have surprisingly found that a eukaryotic microalga extract can act on soil microorganisms involved in the nitrification and denitrification steps of the nitrogen cycle. The microalga extract is preferably supplied to a soil comprising nitrifying microorganisms and/or denitrifying microorganisms. In a particular embodiment of the invention, the fertilization method does not comprise a step of supplying a eukaryotic microalga extract to a plant.

Soil can have an acidic, neutral, or basic pH. Acidic soil is defined as a soil with a pH less than or equal to 6.2. Neutral soil is defined as a soil with a pH comprised between 6.2 and 7.5. Finally, basic soil has a pH greater than or equal to 7.5.

In a particular embodiment, the soil has a pH greater than or equal to a value selected from 6, 6.5, 7, 7.5, or 8.

For example, the soil has a basic pH, that is to say a pH greater than or equal to 7.5. In a particular embodiment, the soil of basic pH has a pH ranging from 7.5 to 8.5, in particular a pH close to 8.0 apart from measurement variations.

Soil can come in different textures. Soil textures can be selected from heavy clay, silty clay, clay, clayey silt loam, clay loam, very fine silt, fine silt, sandy clay, silt, sandy clay loam, sandy silt, silty sand, sand, and mixtures thereof.

In a particular implementation, the soil has a cation exchange capacity (CEC) ranging from 10 meq/kg to 350 meq/kg, for example ranging from 50 meq/kg to 250 meq/kg, or ranging from 180 meq/kg to 200 meq/kg.

The grain size of the soil can be comprised between 1 mm and 5 mm, for example comprised between 1.5 mm and 3 mm.

Finally, the soil can contain organic matter in a content ranging from 0.1% to 15% by mass relative to the mass of the soil.

The cation exchange capacity, the grain size and the organic matter content of a soil are amounts known to the person skilled in the art who knows how to measure them using standard methods.

The microalga extract can be added to the soil via a culture solution. For the purposes of the present invention, the term “culture solution” means any solution that allows the cultivation of a plant, such as, for example, irrigation water, a liquid solution intended for fertigation by sprinkling or drip irrigation, or a hydroponic bath.

The microalga extract or the agricultural product comprising the microalga extract is applied to soil, for example in open fields or by a soilless method. The aqueous extract may be applied to the soil surface or mixed with the soil, for example with the first layers of soil. The application may be carried out directly on the soil, over the entire soil surface or locally, by any suitable distribution means.

The addition of microalga extract to the soil can be carried out before and/or during the growth of cultivated plants, before and/or after germination of plants, or during transplanting in the case of plants requiring transplanting.

The fertilization method of the invention may comprise one or more steps of applying the microalga extract, as well as one or more steps of applying a fertilizer, such as for example a solid or liquid fertilizer, an amendment, and/or a biostimulant. The person skilled in the art will be able to adapt the sequence of steps and the number of repetitions of the steps according to the nature of the soil and/or the cultivated plant.

In a particular embodiment of the invention, the aqueous extract is formulated into a fertilizer before its application to the soil, so that the application of the fertilizer and the application of the microalga extract are simultaneous. The fertilizer is advantageously selected from nitrogen fertilizers comprising an ammoniacal form of nitrogen, nitrogen fertilizers releasing ammonium into the soil, nitrogen fertilizers comprising nitrate, and combinations thereof.

Thus, in a particular embodiment of the invention, the fertilization method involves the use of an agricultural product comprising the microalga extract described above, and optionally at least one nutrient ingredient of the soil and/or one nutrient ingredient of a plant cultivated on the soil selected from a fertilizer, an amendment, a biostimulant and a micronutrient.

The term “fertilizer” refers to fertilizing materials whose main function is to provide plants with elements directly useful for their nutrition (major fertilizing elements, secondary fertilizing elements and trace elements). The term “amendment” refers to a substance intended to improve soil quality, and in particular intended to improve soil pH. Advantageously, the amendment is selected from basic mineral amendments of the limestone and/or limestone and magnesium type, humic soil amendments of the compost type or manure.

The fertilizer is advantageously a simple, binary or ternary solid fertilizer, organo-mineral or organic fertilizer, liquid or a water-soluble fertilizer.

In one embodiment, the fertilizer is a nitrogen fertilizer. It is preferably a nitrogen fertilizer comprising an ammoniacal form of nitrogen, a nitrogen fertilizer releasing ammonium into the soil, or a nitrogen fertilizer comprising nitrate.

In particular embodiments, the nitrogen fertilizer contains ammonium, nitrate, ammonia, and/or urea, wherein the urea may be formulated to slow the release of nitrogen into the soil. Examples of ammonium-containing fertilizers are calcium ammonium nitrate, calcium and ammonium nitrate, ammonium sulfate nitrate, ammonium sulfate, and ammonium phosphate. An example of an ammonia-containing fertilizer is ammonium nitrate. The nitrogen fertilizer may also provide other nutrients, for example, potassium (K) and/or phosphorus (P).

The amendment can be an organic amendment or a mineral amendment, such as calcium carbonate.

Micronutrients such as molybdenum, zinc, boron and copper are preferably supplied as salts soluble in water or organic acids.

A biostimulant can be, for example, a liquid root or foliar biostimulant.

The agricultural product may also comprise at least one formulation aid selected from a solvent, a solid support, a dispersant or an emulsifier, an organic or inorganic thickener, a pesticidal agent, an antifreeze agent, an anti-foaming agent, where appropriate a colorant, a sticking agent or a binder.

The agricultural product may be in the form of a fertilizer or a culture solution that is applied to the soil. When the soil is a culture medium, the microalga extract may have been introduced into the culture medium during its manufacture.

In particular embodiments, the agricultural product according to the invention is a culture solution such as irrigation water, a solution intended for fertigation by sprinkling or drip irrigation, a hydroponics bath or an aeroponics solution.

The agricultural product according to the invention may be in solid form, in particular in the form of powder, granules or microgranules, or in liquid form, in particular in the form of liquid suspension, gel or solution in water.

The expression “plant” is intended to designate in this application the plant considered as a whole, including its root system, its vegetative system, the seeds, grains and fruits.

The invention is suitable for use in the treatment of soil in which a very wide variety of plants can be planted. Among said plants, mention will be made in particular of large-scale crops such as cereals (wheat, corn, barley), protein crops (peas), oilseeds (soybeans, sunflowers), solanaceous crops (potatoes), amaranthaceae crops (beetroot), specialized crops such as in particular market gardening (lettuce, spinach, onion, shallot, tomato, melon), vines, arboriculture (pears, apples, nectarines), or horticulture.

The plant may belong to the order Monocotyledons, preferably to the Poaceae family. Poaceae, commonly called grasses, in particular include most of the species commonly called “grasses” and “cereals”. Poaceae include wheat, rice, barley, oats, rye, sugarcane, meadow, and corn.

The microalga extract can be obtained by any method known to the person skilled in the art.

The microalgae used to prepare the extract is cultivated under culture conditions according to the general knowledge of the person skilled in the art using one of the following three culture modes: autotrophic, mixotrophic or heterotrophic. The culture method may comprise a step under the conditions of one of the three previous modes, combined with a passage in phototrophy.

In a particular embodiment, the microalga extract is obtained by a method comprising the following steps:
A step of extraction by introducing the microalga into a liquid extraction medium, the extraction being carried out at a temperature ranging from 4° C. to 300° C. for a time sufficient to extract the molecules contained in the microalga,
A filtration or centrifugation step to remove solids, and
A step of recovering the filtrate comprising the extract.

The method may comprise a step of cultivating the microalgae in accordance with the preceding description. The preparation of the microalga extract may alternatively be carried out by any extraction method well known to the person skilled in the art such as hot decoction, maceration, extrusion, extraction under subcritical conditions, extraction assisted by ultrasound, with or without grinding such as ultrasonic grinding or using a mixer. The extraction may be carried out at a temperature ranging from 4° C. to 300° C., preferably at a temperature ranging from 19° C. to 25° C.

The liquid extraction medium may comprise water, preferably distilled water and optionally an aliphatic alcohol, for example ethanol or a glycol. In this case, the method for preparing the microalga extract may comprise an additional step of drying or concentration, for example by freeze-drying, or by evaporation at a temperature ranging from 20° C. to 80° C.

In another exemplary embodiment, the liquid extraction medium contains an oil, preferably a vegetable oil, and more preferably an oilseed oil such as rapeseed oil or soybean oil.

In a particular embodiment, the aqueous microalga extract is prepared according to a method comprising the introduction of the microalga into a liquid medium consisting of distilled water, followed by a filtration step to separate the filtrate containing the hydrophilic molecules and organelles contained in the cells, and the solid residues of the microalga. The extraction step can be carried out at a temperature of 4° C. to 300° C., for a duration ranging from 30 minutes to 24 hours.

The extraction step may comprise the addition to the aqueous extraction medium of at least one enzyme allowing the degradation of the wall of the microalgae and the release of their contents into the liquid extraction medium. At least one enzyme selected from pectinases and carbohydrases may thus be added to the liquid extraction medium during the extraction step to obtain a functionalized aqueous extract. Examples of carbohydrases are cellulases, hemicellulases, beta-glucanases, and xylanases.

The present description provides the following list of particular embodiments:

1. A use of an aqueous extract of at least one eukaryotic unicellular microalga to induce an inhibition of at least one step of the nitrogen cycle in a soil, said step being selected from a nitrification process, a denitrification process and a nitrification-denitrification process.

2. The use according to mode 1, characterized in that the microalga is selected from the group consisting of Nannochloropsis sp., Amphora sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nitzchi sp., Odonthella sp., Porphyridium sp., Phaeodacylum sp., Scenedesmus sp., Schyzotrium sp., Skeletonema sp., Thalassosira sp. and Tetraselmis sp.

3. The use according to mode 1 or 2, characterized in that the inhibition of a nitrification process has at least one effect selected from an inhibition of the activity of nitrifying bacteria present in the soil, a reduction in the loss of fertilizer from the soil, a reduction in the leaching of nitrates in the soil, an increase in the amount of ammonium available in the soil, an improvement in the growth of a plant cultivated on the soil, a reduction in nitrous oxide emissions, and an increase in the amount of nitrogen assimilable by a plant cultivated on the soil.

4. The use according to mode 1 or 2, characterized in that the inhibition of a denitrification process has at least one effect selected from an inhibition of the activity of denitrifying bacteria present in the soil, an inhibition of the nitrate reduction process, an inhibition of the activity of the nitrate reductase enzyme, and a reduction in the emission of nitrous oxide.

5. The use according to mode 1, characterized in that the aqueous extract is capable of being obtained by extraction of the molecules that the microalga contains, with a liquid medium containing water.

6. The use according to the preceding mode, characterized in that the aqueous extract is functionalized by adding at least one enzyme selected from carbohydrases and pectinases in the liquid medium.

7. An agricultural fertilization method comprising a step of supplying to a plant an aqueous extract of at least one microalga selected from the group consisting of Nannochloropsis sp., Amphora sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nitzchi sp., Odonthella sp., Porphyridium sp., Phaeodacylum sp., Scenedesmus sp., Schyzotrium sp., Skeletonema sp., Thalassosira sp. and Tetraselmis sp., said extract being able to be applied to a soil provided by a culture medium or provided by a culture solution.

8. The agricultural fertilization method according to the preceding method, further comprising a step of applying at least one nitrogen fertilizer to the soil or to the plant cultivated on the soil, said application step being prior to, concomitant with or subsequent to the step of adding the aqueous extract.

9. The agricultural fertilization method according to the preceding mode, characterized in that the nitrogen fertilizer is a nitrogen fertilizer comprising an ammoniacal form of nitrogen, a nitrogen fertilizer releasing ammonium into the soil, or a nitrogen fertilizer comprising nitrate.

10. A product for agricultural use comprising an aqueous extract of at least one microalga selected from the group consisting of Nannochloropsis sp., Amphora sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nitzchi sp., Odonthella sp., Porphyridium sp., Phaeodacylum sp., Scenedesmus sp., Schyzotrium sp., Skeletonema sp., Thalassosira sp. and Tetraselmis sp., and at least one soil nutrient ingredient and/or one nutrient ingredient of a plant cultivated on the soil selected from a fertilizer, an amendment, a biostimulant and a micronutrient.

11. The product for agricultural use according to the preceding mode, characterized in that it is in the form of a fertilizer, a culture medium or a culture solution.

12. A method for preparing an aqueous extract of at least one microalga selected from the group consisting of Nannochloropsis sp., Amphora sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nitzchi sp., Odonthella sp., Porphyridium sp., Phaeodacylum sp., Scenedesmus sp., Schyzotrium sp., Skeletonema sp., Thalassosira sp. and Tetraselmis sp., said method comprising the following steps:
A step of extraction by introducing the microalga into a liquid extraction medium comprising water, the extraction being carried out at a temperature ranging from 4° C. to 300° C. for a time sufficient to extract the molecules contained in the microalga,
A filtration step to remove solids, and
A step of recovering the filtrate comprising the aqueous extract.

13. The process according to the preceding mode, characterized in that at least one enzyme selected from pectinases and carbohydrases is added to the liquid extraction medium during the extraction step to obtain a functionalized aqueous extract.

The invention is also illustrated by the following examples. Unless otherwise stated, the temperature is room temperature comprised between 20° C. and 25° C. and the pressure is atmospheric pressure.

### Example 1: Preparation of Microalga Extracts

### First Extract:

Distilled water and a phototrophically cultivated microalgae are introduced into a glass reactor at a mass concentration of 2.5%. After stirring (for 4 hours) and decanting, the filtrate is collected and constitutes the “Extract”. The microalga is, for example, a microalga of the genus Nannochloropsis sp., of the genus Arthrospira sp. or of the genus Chlorella, in particular a microalga of the species Nannochloropsis salina, Nannochloropsis oculata, Nannochloropsis oceanica, Arthrospira platensis, Chlorella sorokiniana or Chlorella vulgaris.

### Second Extract:

Water and the microalga are introduced into a glass reactor at a mass concentration of 2.5%. After stirring (for 4 hours), the Viscozyme® L enzyme complex is added at a concentration of 0.1% (enzyme/raw material weight). The enzymatic functionalization of the extract lasts 5 hours under stirring. After decantation, the filtrate is collected and constitutes the “Functionalized Extract”. The microalga is for example a microalga of the genus Nannochloropsis sp., of the genus Arthrospira sp. or of the genus Chlorella, in particular a microalga of the species Nannochloropsis salina, Nannochloropsis oculata, Nannochloropsis oceanica, Arthrospira platensis, Chlorella sorokiniana or Chlorella vulgaris.

### Third Extract:

Oil and a microalga cultivated in phototrophy are introduced in a glass reactor at a mass concentration of 2.5%. After stirring (for 16 hours) and decanting, the filtrate is collected and constitutes the “Extract in oil”. The microalga is for example Chlorella sorokiniana or Nannochloropsis oceanica.

### Example 2: Measurement of Nitrification Inhibition by Measuring Ammonium in Soil

Preparation of a Soil that Comprises a Microalga Extract (Extract or Functionalized Extract) and a Soil that does not Comprise a Microalga Extract (Control)

5 g of dry soil from a surface soil located in France (the characteristics of which are detailed in Table 1) were sieved with a sieve with a mesh diameter of 2 mm, and placed in 60 ml glass vials to which 0.8 ml of water containing the treatment (Extract or Functionalized Extract of Example 1) at a dose of 50 mg/Vial or not containing said treatment (Control) were added.

TABLE 1
Main soil characteristics

| Texture | Silty clay |
|---|---|
| pH | 8.1 |
| Organic matter (%) | 1.9 |
| Cation exchange capacity (meq/kg) | 187 |

After 24 hours of incubation, 0.4 mg of N-NH₄⁺·g⁻¹ Sol, in the form of ammonium sulfate, are added to 1.8 ml of water. This volume allows 80% of the field capacity of the soil studied to be reached.

The vials are then hermetically sealed and incubated at 20° C. to 22° C. for up to 12 days. During this period, the nitrification kinetics in the soil are established by performing ammonium measurements at 2; 6; 9 and 12 days.

Extraction and Determination of Ammonium from the Soil

Extraction is carried out by adding 15 mL of a 1M KCl solution to each vial then shaking with a rotary shaker for one hour. The vials are left to settle for 10 min. The supernatant is collected and centrifuged at 11 000 rpm (rotations per minute) for 5 min at 4° C. then filtered through a 0.25 μm filter to remove any particles.

The ammonium assay is carried out using the Spectroquant Ammonium test kit (Supelco). After dilution of the filtrate, 5 ml are used to perform the assay. The Optical Density (OD) of the samples is measured using a spectrophotometer at 692 nm and the NH₄⁺ content was estimated from a calibration curve.

For each of the incubation conditions (Control, Extract and Functionalized Extract), four batches of soil were created (1 batch=1 biological repetition).

All treatments were carried out systematically for each of the biological replicates, that is to say in quadruplicate. The data obtained were presented as means and the variability of the results was given as the standard deviation of the mean for n=4.

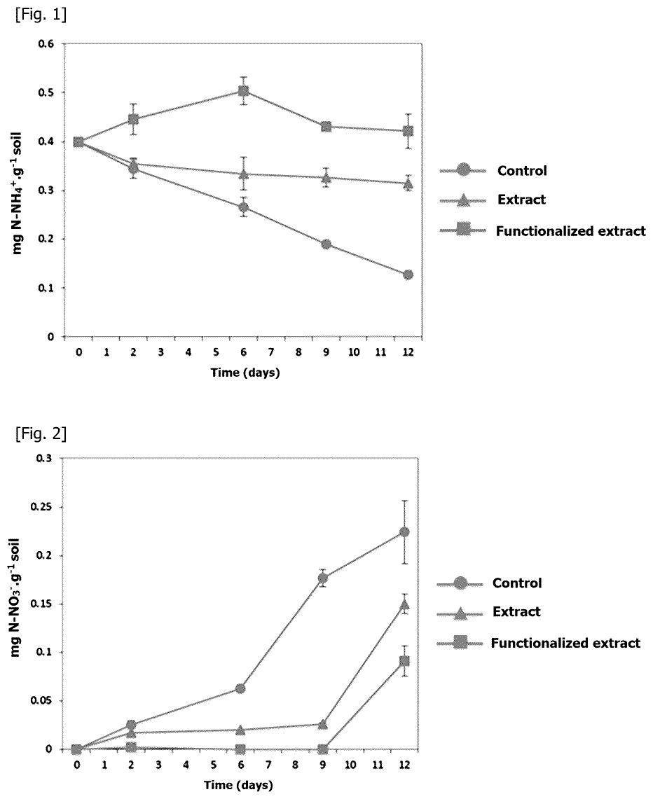

The ammonium dosage is shown in FIG. 1. Conclusion: Soils treated with the Extract or Functionalized Extract have ammoniacal nitrogen (N—NH₄⁺) contents, that is to say the mass of the nitrogen element present in the form of ammonium, higher than that found in the control soil. An increase of +158% in the presence of the extract and +250% in the presence of the functionalized extract is observed after 12 days of incubation, reflecting a decrease in nitrifying activity also called inhibition of nitrification.

### Example 3: Measurement of Nitrification Inhibition by Measuring Nitrates in Soil

Preparation of a Soil that Comprises a Microalga Extract (Extract or Functionalized Extract) and a Soil that does not Comprise a Microalga Extract (Control)

Vials were prepared under the same conditions as described in Example 2.

The nitrification kinetics associated with the appearance of nitrate in the soil were established by performing nitrate assays at 2; 6; 9 and 12 days.

Extraction and Determination of Nitrates from the Soil

Extraction is carried out by adding 15 mL of pure water to each vial then shaking with a rotary shaker for one hour. The vials are left to settle for 10 min. The supernatant is collected and centrifuged at 11 000 rpm (rotations per minute) for 5 min at 4° C. then filtered through a 0.25 μm filter to remove any particles.

Nitrate determination is carried out using the Spectroquant Nitrate test kit (Supelco). After dilution of the filtrate, 5 ml are used to carry out the determination. The Optical Density (OD) of the samples is measured using a spectrophotometer at 692 nm and the nitrate nitrogen content (N—NO₃⁻), that is to say the mass of the nitrogen element present in the nitrate, was estimated from a calibration curve.

For each of the incubation conditions (Control, Extract and Functionalized Extract), four batches of soil were created (1 batch=1 biological repetition).

All treatments were carried out systematically for each of the biological replicates, that is to say in quadruplicate. The data obtained were presented as the mean and the variability of the results was given as the standard error of the mean for n=4.

The result of the nitrate ion dosage is shown in FIG. 2. Conclusion: Soils treated with the Extract or Functionalized Extract have lower nitrate nitrogen (N—NO₃⁻) contents than those found in the control soil. A decrease of −31% in the presence of the Extract and −59% in the presence of the Functionalized Extract is observed after 12 days of incubation, reflecting a decrease in nitrifying activity also called inhibition of nitrification.

### Example 4: Determination of Nitrous Oxide (N₂O) in Soil

Preparation of a Soil that Comprises a Microalga Extract (Functionalized Extract) and a Soil that does not Comprise a Microalga Extract (Control)

4.4 g of dry soil (kept at 15% mass humidity) sieved with a sieve with a mesh diameter of 1 mm, are placed in 37 ml glass vials to which 0.6 ml of water containing 0.4 mg of N-NH₄⁺·g⁻¹ Sol, in the form of ammonium sulfate, are added. The microalga extract prepared according to Example 1 was applied at a dose of 25 mg/Vial.

The vials are then hermetically sealed and incubated at 20° C. for up to 216 hours. During this period, the nitrification kinetics associated with the appearance of N₂O are established by performing N₂O measurements at 0; 48; 120; 168 and 216 hours.

Nitrification kinetics were also evaluated under the same conditions as previously on the same soil not comprising any microalga extract used as a control.

### Sampling and Determination of N₂O Gas

The gas is taken with a syringe from the gas atmosphere of the vials, and the determination is carried out on a microGC (Agilent 990) equipped with a TCD detector and a Porapak Q column.

For each of the incubation conditions (Control and Functionalized Extract), three batches of soil were created (1 batch=1 biological repetition).

All treatments were carried out systematically for each of the biological repetitions, that is to say in triplicate. The data obtained were presented as the mean and the variability of the results was given as the standard deviation of the mean for n=3.

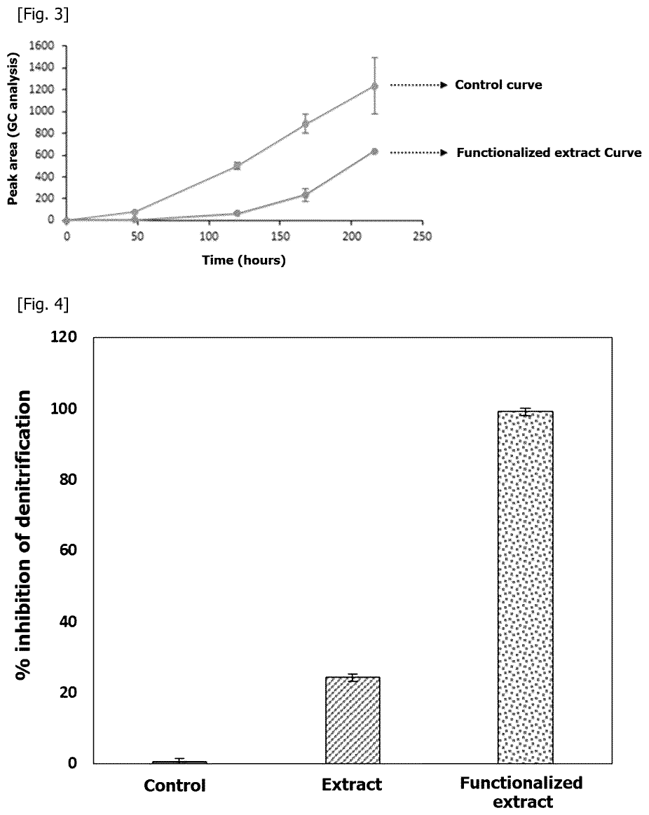

N₂O dosage is shown in FIG. 3.

Conclusion: Soils treated with the Functionalized Extract have lower Nitrous Oxide (N₂O, here represented by the peak area) contents than those found in the control soil. A decrease of −50% in the presence of the functionalized extract is observed after 216 hours of incubation.

### Example 5: Measurement of the Inhibition of the Denitrification Process by Measuring the Activity of the Enzyme Nitrate Reductase

In a 96-well round-bottom plate are placed a 10 mM phosphate buffer pH 7.5, the enzyme nitrate reductase (Sigma Aldrich, N0163), and a substrate buffer pH 7.5 (containing 37.5 mM phosphate buffer pH 7.5, 15 mM potassium nitrate, 0.075 mM EDTA, 0.15 mM NADH) to which are added 0.8 ml of water containing the treatment (Extract, Functionalized Extract or Extract in Oil of Example 1) at a dose of 50 mg/Vial or not containing it (Control). The plate was then incubated at 30° C. for 40 minutes with shaking in the dark and followed by the addition of 58 mM sulfanilamide (Sigma Aldrich, S9251) with freshly prepared N-(1-naphthyl)ethylenediamine dihydrochloride (Sigma Aldrich, 222488). The plate was again incubated for 20 minutes at room temperature in the dark for complete color development. Then, the absorbance was measured at 540 nm in a UV spectrophotometer (ClarioStar Plus, BMG Labtech).

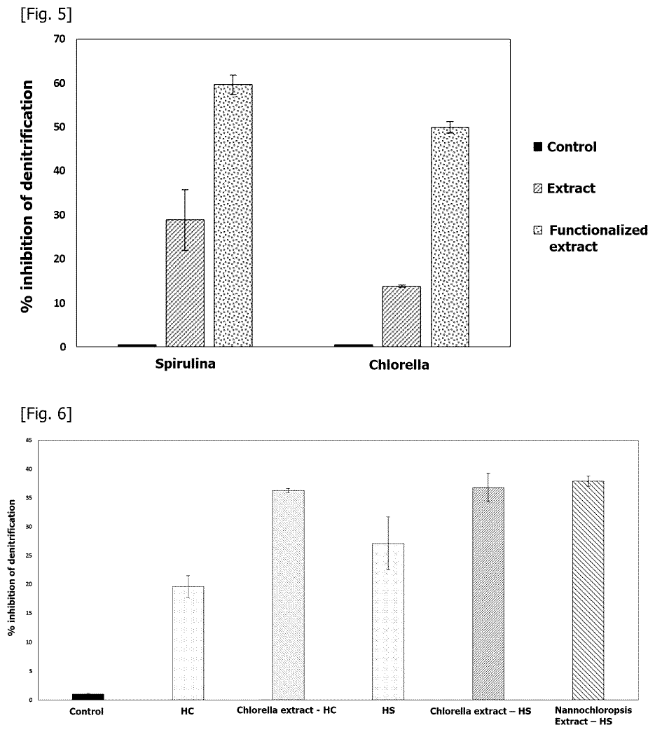

The results are shown in FIG. 4, FIG. 5 and FIG. 6. Conclusion: The enzyme treated with the Extract or Functionalized Extract of Nannochloropsis saliuna, Nannochloropsis oculata or Nannochloropsis oceanica shows a greater inhibition of the activity of the nitrate reductase enzyme than that found in the control solution. An inhibition of denitrification of 24% in the presence of the Extract and 99% in the presence of the Functionalized Extract of Nannochloropsis saliuna, Nannochloropsis oculata, Nannochloropsis oceanica is observed, reflecting an inhibition of denitrifying activity (FIG. 4).

The enzyme treated with the Extract or Functionalized Extract of Arthrospira platensis (spirulina) or Chlorella sorokiniana (chlorella) has a greater inhibition of nitrate reductase enzyme activity than that found in the control solution. An inhibition of denitrification of 59.6% in the presence of Functionalized Spirulina Extract and 49.9% in the presence of Functionalized Chlorella Extract is observed, reflecting an inhibition of denitrifying activity (FIG. 5). The enzyme treated with oil or Extract in oil of Chlorella sorokiniana (chlorella) or Nannochloropsis oceanica has a greater inhibition of nitrate reductase enzyme activity than that found in the control solution. A 19.6% inhibition of denitrification in the presence of rapeseed oil and 36.3% in the presence of chlorella extract in rapeseed oil is observed, reflecting an inhibition of denitrifying activity. A 27.2% inhibition of denitrification in the presence of soybean oil and 36.8% in the presence of chlorella extract in soybean oil, and 37.9% in the presence of nannochloropsis extract in soybean oil is observed, reflecting an inhibition of denitrifying activity (FIG. 6).

1. A method for fertilizing a soil harboring microorganisms, said method comprising a step of adding at least one eukaryotic microalga extract to said soil.

2. The method for fertilizing a soil according to claim 1, wherein the microalga is selected from the group consisting of Amphora sp., Arthrospira sp., Chaetoceros sp., Chlamydomonas sp., Chlorella sp., Dunaliella sp., Euglena sp., Fragilaria sp., Haematococcus sp., Isochrysis sp. Tisochrysis sp., Nannochloris sp., Nannochloropsis sp., Nitzchi sp., Odonthella sp., Porphyridium sp., Phaeodacylum sp., Scenedesmus sp., Schyzotrium sp., Skeletonema sp., Thalassosira sp. and Tetraselmis sp.

3. The method for fertilizing a soil according to claim 1, wherein the step of adding the microalga extract causes the inhibition of the activity of the microorganisms.

4. The method for fertilizing a soil according to claim 1, wherein the step of adding induces an inhibition of at least one step of the nitrogen cycle in the soil, said step being selected from the group consisting of a nitrification process, a denitrification process and a nitrification-denitrification process.

5. The method for fertilizing a soil according to claim 4, wherein the inhibition of a nitrification process has at least one effect selected from the group consisting of a reduction in the loss of fertilizer from the soil, a reduction in the leaching of nitrates in the soil, an increase in the amount of ammonium available in the soil, a reduction in nitrous oxide emissions, and an increase in the amount of nitrogen assimilable by a plant cultivated on the soil.

6. The method for fertilizing a soil according to claim 4, wherein the inhibition of a denitrification process has at least one effect selected from the group consisting of an inhibition of the nitrate reduction process, an inhibition of the activity of the nitrate reductase enzyme, and a reduction in the emission of nitrous oxide.

7. The method for fertilizing a soil according to claim 1, wherein the extract is obtained by an extraction process in a liquid medium which contains water or an oil.

8. The method for fertilizing a soil according to claim 7, wherein the liquid medium comprises water and at least one enzyme, which is selected from carbohydrases and pectinases.

9. The method for fertilizing a soil according to claim 1, wherein the soil has a pH greater than or equal to 6.

10. The method for fertilizing a soil according to claim 1, wherein the soil comprises a nitrogen fertilizer.

11. The method for fertilizing a soil according to claim 1, comprising a step of using an agricultural product comprising the eukaryotic microalga extract.
